(19) United States
(12) Patent Application Publication
(10) Pub. No.: US 2005/0252620 A1
(43) Pub. Date: Nov. 17, 2005

(54) Electromotive transmission structure of blind

(76) Inventor: Cheng Long Lin, Taipei Hsien (TW)

Correspondence Address: Cheng Long Lin, 235 Chung - Ho, Box 8-24, Taipei, TW

(21) Appl. No.: 10/843,468

(22) Filed: May 12, 2004

(51) Int. Cl. E06B 3/92

(52) U.S. Cl. 160/168.1 P

(57) ABSTRACT

An electromotive transmission structure of a blind comprises a box body and a base. A control unit is installed on the base; and a motor serves for driving an output shaft. A winding wheel is driven by the output shaft. A transmission belt is wound around a wheel shaft of the winding wheel for controlling the blind. A rolling shaft is installed at a lateral side of the winding wheel and a weight is suspended from the winding wheel through a rope. The rope is wound around the rolling shaft and the winding direction of the rope being reverse to that of the transmission belt around the wheel shaft of the winding wheel; the weight passing through the via hole of the box body. When the blind is at a full open or a full closing position, the control unit will stop the motor.

### FIELD OF THE INVENTION

The present invention relates to blinds, and particular to an electromotive transmission structure of a blind, wherein a motor is used to control the opening or closing operation of the blinds so that the blind can open or close. Moreover, as the blind is in a full open position or in a full close position, the motor can stop by electrical control.

### BACKGROUND OF THE INVENTION

With reference to FIG. 1, a prior art electromotive blind is illustrated. In the prior art, a bi-directional motor is installed at one side of a track 51 of a blind. The control unit 52 serves to actuate the motor 50 to rotate bi-directionally. The power of the motor 50 outputs through a rotary shaft 54 to drive a guide wheel 53 a stop release or rewind the rope 55. Thereby, the object of con trolling the blind is achieved.

However, the prior art design needs many components and the assembly work is complicated so that the cost in manufacturing is expensive. Moreover, when the motor 50 is actuated to drive the guide wheel 53 to rotate. It is often that the wheel cannot rotate successfully or the power transmission is not efficient. When the blind descends to a lowest level, the height of the blind is detected by optics and timing devices to transfer the detected signals to the control unit 52 so as to determine the stop timing of the motor. Thereby, the control process is complicated. Moreover, the detecting and timing devices are installed at one lateral side of the blind, they are easily destroyed due to sunshine or rain.

### SUMMARY OF THE INVENTION

Accordingly, the primary object of the present invention is to provide an electromotive transmission structure of a blind, wherein a motor is used to control the opening or closing operation of the blinds so that the blind can open or close automatically. Moreover, as the blind is in a full open position or in a full close position, the motor can stop by electrical control.

To achieve above objects, the present invention provides an electromotive transmission structure of a blind which comprises a box body and a base. A control unit is installed on the base; and a motor serves for driving an output shaft. A winding wheel is driven by the output shaft. A transmission belt is wound around a wheel shaft of the winding wheel for controlling the blind. A rolling shaft is installed at a lateral side of the winding wheel and a weight is suspended from the winding wheel through a rope. The rope is wound around the rolling shaft and the winding direction of the rope being reverse to that of the transmission belt around the wheel shaft of the winding wheel; the weight passing through the via hole of the box body. When the blind is at a full open or a full closing position, the control unit will stop the motor.

The various objects and advantages of the present invention will be more readily understood from the following detailed description when read in conjunction with the appended drawing.

### BRIEF DESCRIPTION OF THE DRAWINGS

FIG. 1 is an assembled schematic view of the transmission structure of a prior art blind.

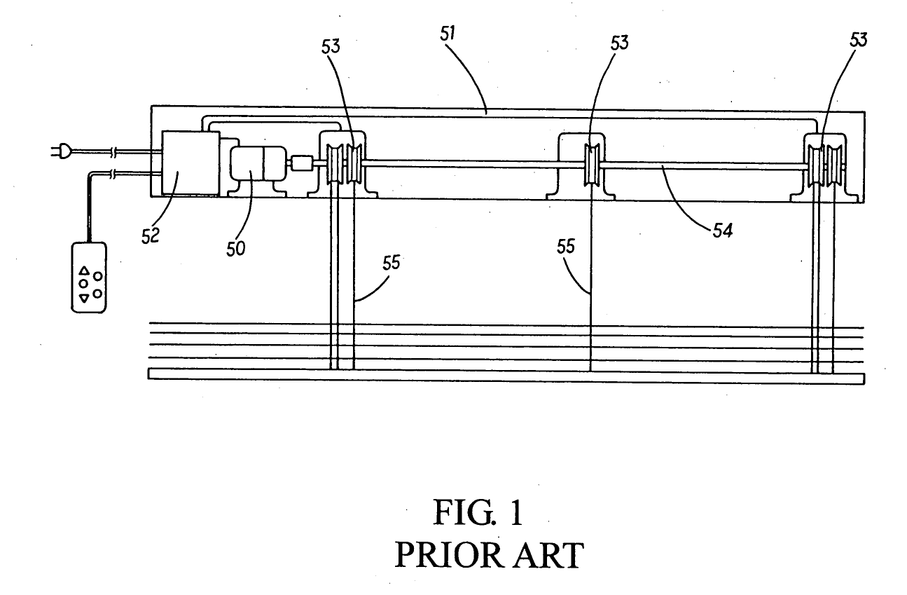

FIG. 2 is an exploded perspective view of the present invention.

FIG. 3 is an assembled perspective view of the present invention.

FIG. 4 is a lateral view of the present invention.

FIG. 5 is a schematic view showing the operation of the present invention.

FIG. 6 is a schematic view of the present invention, where the blind descends to a lowest level.

FIG. 7 is a schematic view of the present invention, where the blind descends to a highest level.

### DETAILED DESCRIPTION OF THE INVENTION

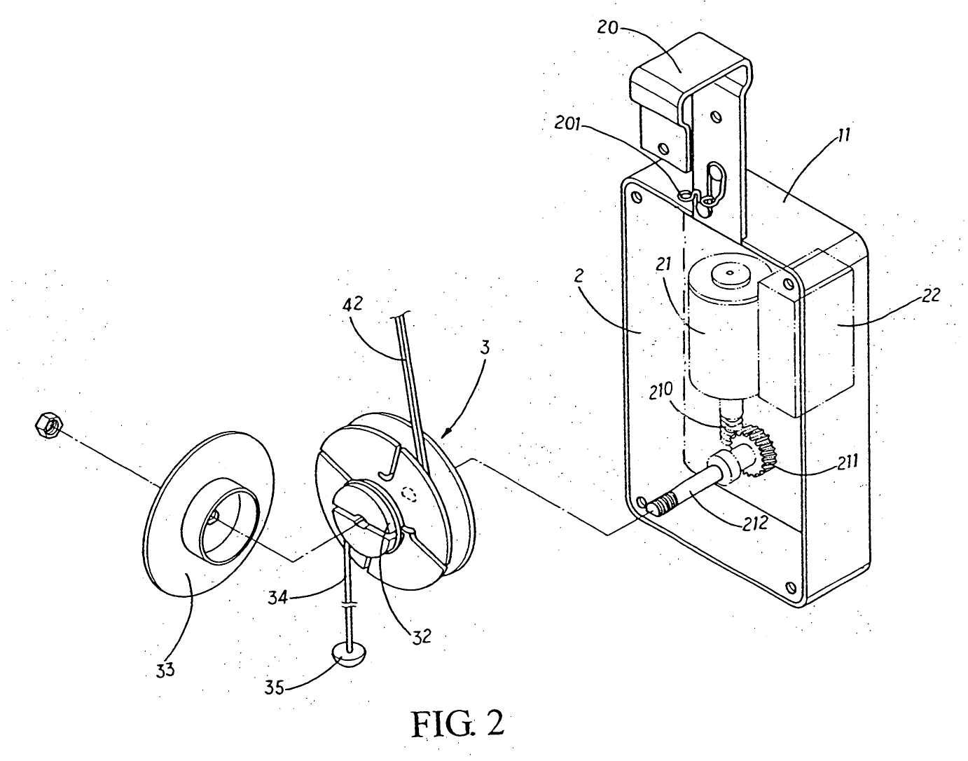

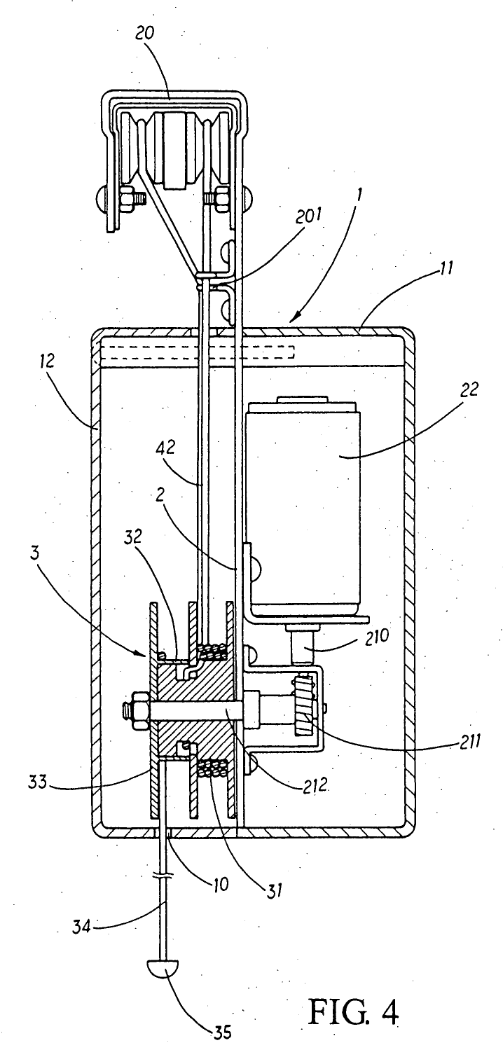

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims. With reference to FIGS. 2 to 4, the electromotive transmission structure of a blind of the present invention is illustrated. The transmission structure includes a box body 1, a base 2, and a winding wheel 3.

The box body 1 is formed by a seat 11 and a cover body 12. A bottom of the box body 1 has a via hole 10 A top of the base 2 has a hook 20 which is firmly secured to a lateral side of the track 41 of the blind 4.

A motor 21 and a control unit 22 are installed at a rear side of the base 2. The spindle 210 of the motor 21 drives a deceleration gear 211 and then the deceleration gear 211 drives an output shaft 212

A winding wheel 3 is driven by the output shaft 212. A transmission belt 42 is wound around a wheel shaft of the winding wheel 3 for controlling the opening and closing of the blind 4. The transmission belt 42 passes through an ear hole 201 at a lower end of the hook 20. A rolling shaft 32 is installed at a lateral side of the winding wheel 3 and a weight 35 is suspended from the winding wheel 3 through a rope 34. The rope 34 is wound around the rolling shaft 32 and the winding direction of the rope 34 is reverse to that of the transmission belt 42 around the wheel shaft 31 of the winding wheel 3. The weight 35 passes through the via hole 10 of the box body 1 for positioning and stabling the rolling of the winding wheel 3.

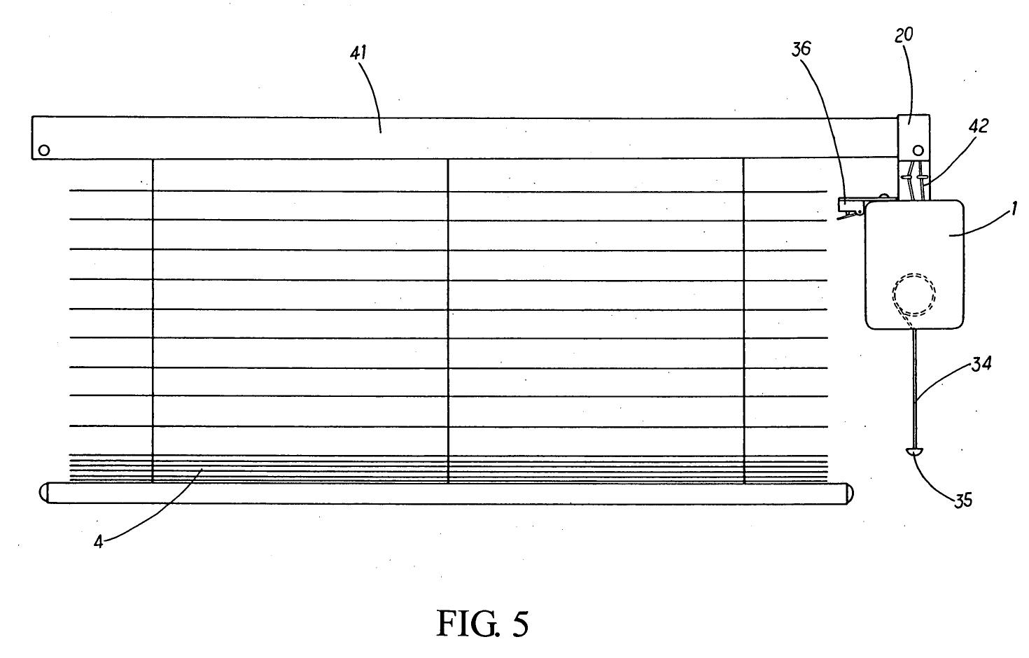

The rotation direction of the motor 21 is controlled manually or wirelessly through the control unit 22 so that the winding wheel 3 can rotate along different directions, see FIG. 5.

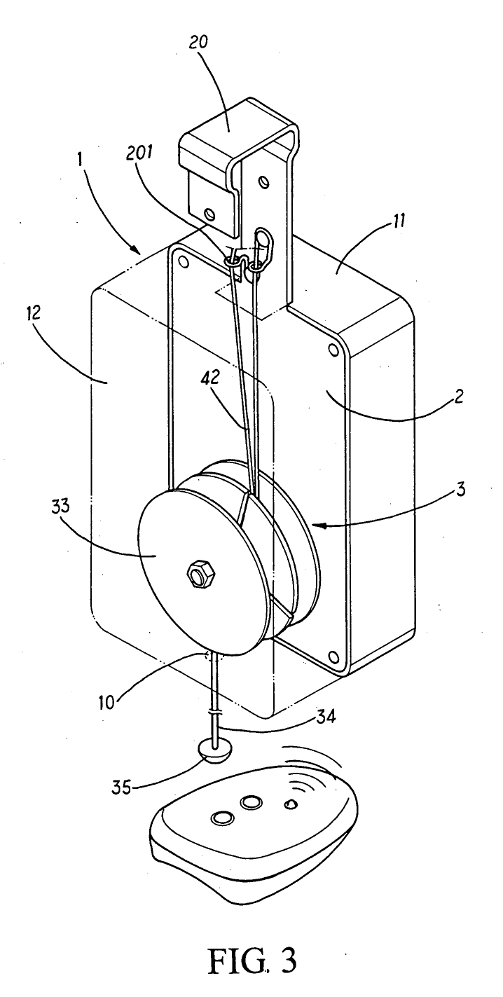

With reference to FIG. 3, a sealing cover 33 is installed at one side of the rolling shaft 32 for confining the rope 34 to retain the rope 34 to wind around or rewind from the rolling shaft 34.

Moreover, in the present invention, the transmission belt 42 can be selected from one of a rope or a chain of beads.

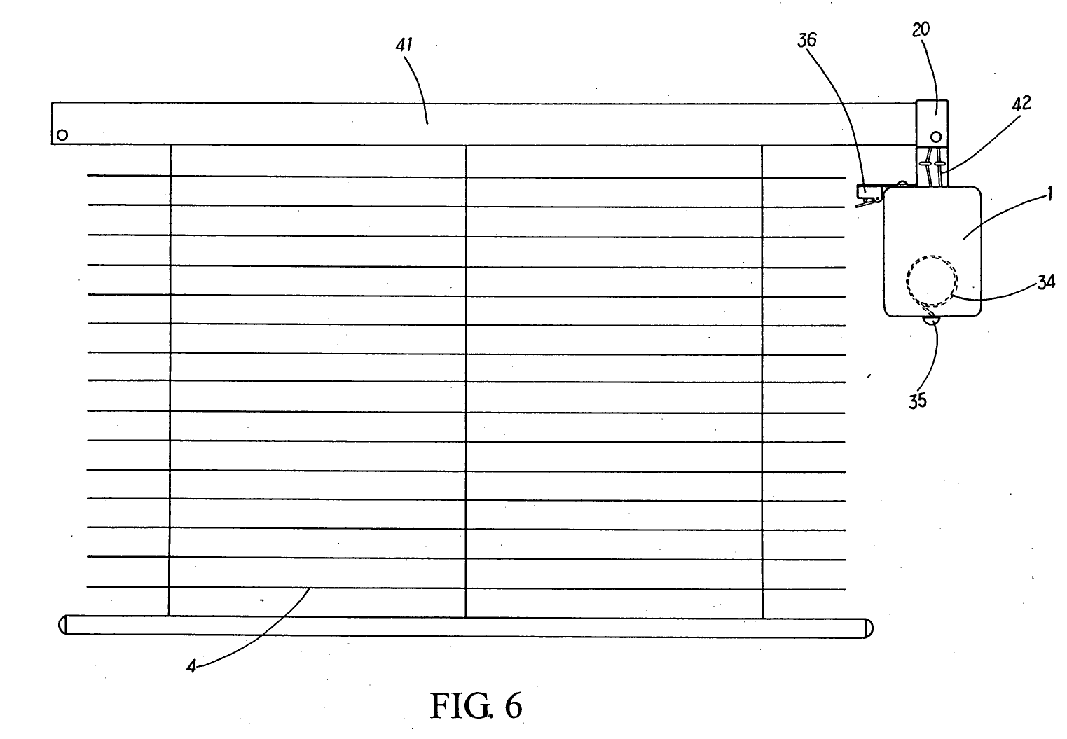

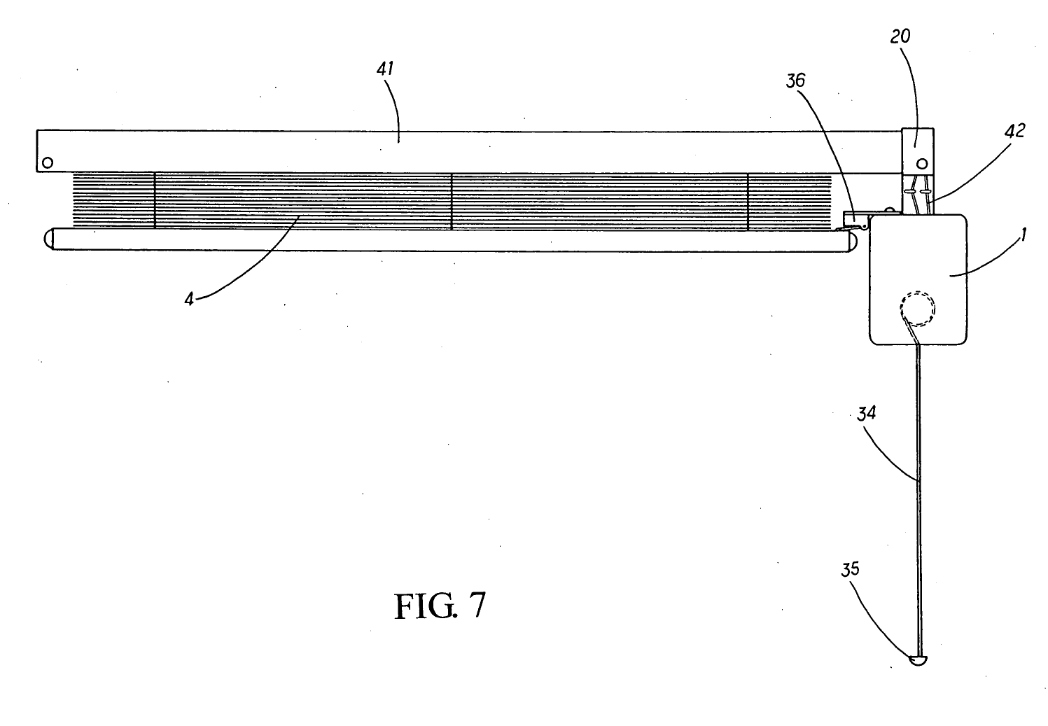

When the transmission belt 42 is released so that the blind 4 descends to a lowest level, the rope 34 will pull the weight 24 to be exactly buckled to a bottom of the box body 1, as shown in FIGS. 6 and 7 so that the winding wheel 3 is braked by the rope 34. Thereby, the control unit 22 will stop the motor 21. Furthermore, when the motor 21 drives the winding wheel 3 to drive the transmission belt 42 to rewind to a highest level of the blind 4. At this stage, the transmission belt 42 cannot rewind again and the winding wheel 3 is stopped. At this moment, the control unit 22 will stop the motor 21.

With reference to FIG. 7, a microswitch 36 can be installed at one end portion of the track 41 of the blind 4. When the motor 21 drives the winding wheel 3 to rotate so as to drive the transmission belt 42 to rewind to open the blind 4 fully or to close the blind 4 fully, at the same time, the microswitch 36 is actuated to stop the motor 21.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. An electromotive transmission structure of a blind comprising:
a box body formed by a seat and a cover body;
a base;
a control unit installed on the base;
a motor for driving an output shaft;
a winding wheel attached to the base; the base and the winding wheel being installed within the box body; the winding wheel being driven by the output shaft;
a transmission belt wound around a wheel shaft of the winding wheel for controlling a blind;
a rolling shaft installed at a lateral side of the winding wheel; and
a weight being suspended from the winding wheel through a rope; the rope being wound around the rolling shaft and the winding direction of the rope being reverse to that of the transmission belt around the wheel shaft of the winding wheel; the weight passing through a via hole of the box body for positioning and stabling the rolling of the winding wheel;
wherein the length of the transmission belt and the length of the weight will cause that when the blind is fully closed, the weight resists against a bottom of the box body and the control unit will stop the motor electrically; and when the blind is fully opened, the weight descends to a lowest position and the control unit also stops the motor electrically.

2. The electromotive transmission structure of a blind as claimed in claim 1, wherein the blind is installed with a microswitch, when the blind is fully closed or fully opened, the microswitch will actuate the motor to stop.

3. The electromotive transmission structure of a blind as claimed in claim 1, wherein a spindle of the motor drives a deceleration gear and then the deceleration gear drives the output shaft;

4. The electromotive transmission structure of a blind as claimed in claim 1, wherein a top of the base has a hook which is firmly secured to a lateral side of a track of a blind.

5. The electromotive transmission structure of a blind as claimed in claim 1, wherein a top of the base has a hook, and a lower end of the hook has two ear holes.

6. The electromotive transmission structure of a blind as claimed in claim 1, wherein the control unit is installed at a rear side of the base; the control unit serves to provide power to the motor and to control the rotation directions of the motor by manual operation or wireless operation.

7. The electromotive transmission structure of a blind as claimed in claim 1, wherein a sealing cover is installed at one side of the rolling shaft for retaining the rope to the rolling shaft as the rope winds around or rewinds from the rolling shaft.

8. The electromotive transmission structure of a blind as claimed in claim 1, wherein the transmission belt is selected from a rope and a chain of beads.
